(19) United States
(12) Patent Application Publication
(10) Pub. No.: US 2018/0095432 A1
(43) Pub. Date: Apr. 5, 2018

(54) OPTIMIZATION SYSTEM

(71) Applicant: NEC Corporation, Minato-ku, Tokyo (JP)

(72) Inventors: ALEXANDER VIEHWEIDER, Tokyo (JP); SHANTANU CHAKRABORTY, Tokyo (JP)

(73) Assignee: NEC Corporation, Minato-ku, Tokyo (JP)

(21) Appl. No.: 15/566,360

(22) PCT Filed: Apr. 21, 2015
(86) PCT No.: PCT/JP2015/002166

§ 371 Date: Oct. 13, 2017

(51) Int. Cl. G05B 13/02; G05B 23/02; G05B 11/32; F24F 11/46

(52) U.S. Cl. CPC G05B 13/024; G05B 23/0205; G05B 15/02; G05B 13/0265; F24F 11/46; G05B 11/32

(57) ABSTRACT

A plurality of subsystems (21, 22, 23) have one or more internal states. A plurality of local optimizers (11, 12, 13) control the corresponding subsystems based on the internal states thereof and data exchange due to a coupling between the subsystems, respectively. A mediator (10) monitors outputs (y1, y2, y3) and/or some internal states of the plurality of subsystems (21, 22, 23) and controls operations of the plurality of local optimizers (11, 12, 13) based on the internal states and/or outputs thereof. Each of a first subsystem and a second subsystem is one of the plurality of subsystems (21, 22, 23). A first internal state that is the close to the second subsystem in the first subsystem is affected by a second internal state that is close to the first subsystem in the second subsystem, or the first and second subsystems share a common resource.

### TECHNICAL FIELD

The present invention relates to an optimization and/or management system, and, for example, to a mediator based distributed optimization method for coupled dynamic systems.

### BACKGROUND ART

Central management approaches and distributed management approaches are used for optimizing systems that can be divided into a plurality of subsystems.

The central management approaches suffer from the problem that necessary computation of command sequences (or resource sequences) may take too long time to be executed within possibly real time for practical applications. Thus, the conventional central management approach often suffers from the curse of dimensionality. As described above, a central management system is not the fastest available technology since it is unable to handle high dimensional problem. Therefore, the central management system cannot be applied to the high dimensional dynamic system such as a high dimensional dynamic non-linear system.

On the other hand, distributed management systems can solve the above-mentioned problem sufficiently when couplings of the subsystems are loose. In the distributed management system, the whole system is generally divided into a plurality of—if possible—loosely coupled subsystems. Each subsystem is managed independently or some subsystems are often managed in parallel with occasional information exchange between the optimizers (managers) of the subsystems.

In PTL 1, a distributed management system (in this case the task to achieve is a search) is introduced. In PTL 1, each agent includes a series of steps. Each agent has as part of its functionality a cooperative controller. This scheme has not the ability for efficient management of the class of systems such as a large system. Major issue is the increase in needed communication, longer convergence time and possible failure of finding a valid solution for the considered task.

Further in NPTL1, a distributed management for hybrid infrastructure is introduced in detail. The distributed management is realized by agents that communicate. The exchange of information between the distributed units (agents) is performed in this scheme.

### CITATION LIST

### Patent Literature

PTL 1: U.S. Pat. No. 6,577,906 B1

### Non Patent Literature

NPL 1: M. Arnold, R. R. Negenborn, G. Andersson, and B. De Schutter, “Distributed Predictive Control for Energy Hub Coordination in Coupled Electricity and Gas Network”, Technical Report 09-050, Delft Center for Systems and Control, Delft University of Technology.

### SUMMARY OF INVENTION

### Technical Problem

However, the inventers have found a problem in PTL1 and NPTL1 as described below. The advantage of the distributed management system cannot be attained when there is a tight coupling between the subsystems or a common resource (common command) shared by the subsystems. In this case, the task executed by the distributed management system cannot be fast converged to a predefined task. In other words, convergence speed and quality of the distributed management system depend on the tightness of the coupling between the subsystems in the distributed management system. This issue is especially important when it comes to real time optimal control of the subsystems.

The present invention has been made in view of the above-mentioned problem, and an object of the present invention is to effectively converge to an operation of a distributed management system even if a scale of the distributed management system is large and some subsystems show heavy coupling.

### Solution to Problem

An aspect of the present invention is an optimization system including: a plurality of subsystems that have one or more internal states; a plurality of local optimizers that control the corresponding subsystems based on the internal states thereof and data exchange due to a coupling between the subsystems, respectively; and a mediator that monitors outputs and/or some internal states of the plurality of subsystems and controls operations of the plurality of local optimizers based on the internal states and/or outputs thereof. Each of a first subsystem and a second subsystem is one of the plurality of subsystems, and a first internal state that is the close to the second subsystem in the first subsystem is affected by a second internal state that is close to the first subsystem in the second subsystem, or the first and second subsystems share a common resource.

### Advantageous Effects of Invention

According to the present invention, it is possible to effectively converge to an operation of a distributed management system even if a scale of the distributed management system is large and some subsystem show tight coupling.

### BRIEF DESCRIPTION OF DRAWINGS

FIG. 1 is a block diagram schematically showing a configuration of an optimization system according to a first embodiment.

FIG. 2 is a diagram schematically showing an example of tight coupling between two subsystems.

FIG. 3 is a diagram schematically showing another example of tight coupling between two subsystems.

FIG. 4 is a diagram schematically showing an example of loose coupling between two subsystems.

FIG. 5 is a diagram schematically showing another example of loose coupling between two subsystems.

FIG. 6 is a graph schematically showing a parameter change of the optimization system according to the first embodiment.

FIG. 7 is a flowchart showing a process of an operation mode change of the optimization system according to the first embodiment.

FIG. 8 is a plane view schematically showing an example of a floor plan of a building according to a second embodiment.

FIG. 9 is a block diagram schematically showing a configuration of the distributed management system 300 according to the third embodiment.

FIG. 10 is a diagram schematically showing a coalition formation method.

FIG. 11 is a diagram showing an example of ANM generation.

### DESCRIPTION OF EMBODIMENTS

### First Embodiment

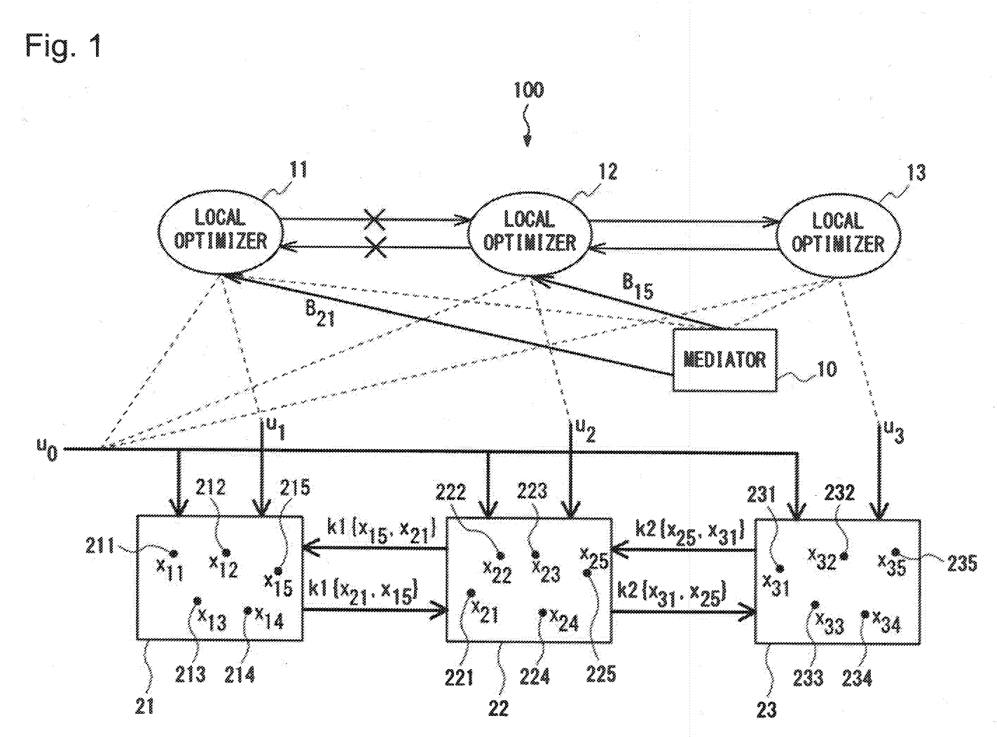

An optimization system according to a first embodiment shall be described. FIG. 1 is a block diagram schematically showing a configuration of an optimization system 100 according to the first embodiment. The optimization system 100 is configured as a distributed management system. The optimization system 100 includes a plurality of local optimizers, a plurality of subsystems, and a mediator. The local optimizers control the corresponding subsystems, respectively. Here, an example in which the optimization system 100 includes three local optimizers 11 to 13 and three subsystems 21 to 23 shall be described. The local optimizers 11 to 13 control the subsystems 21 to 23, respectively. Note that a subsystem may include a physical subsystem itself and the corresponding local optimizer.

Each of the subsystems 21 to 23 has one or more internal states. For example, when the subsystem is an air conditioning system for a room, temperature, humidity, or speed of air flow of a predetermined point in the room is the internal state. The internal state may be a task fulfilling parameter, a management performance indication, or an optimization constraints fulfilling parameter. The task fulfilling parameter can be a certain energy or power level that should be kept under a certain level (ex. Demand Response function with air conditioning). The management performance indication can be convergence speed, time for convergence of local optimizer. The optimization constraints fulfilling parameters can be a parameter that expresses how good the optimization constraints are kept.

In this embodiment, the subsystem 21 has the internal states 211 to 215, the subsystem 22 has the internal states 221 to 225, and the subsystem 23 has the internal points 231 to 235. Conditions of the internal states 211 to 215 are expressed by internal states x11 to x15, respectively. Conditions of the internal states 221 to 225 are expressed by internal conditions x21 to x25, respectively. Conditions of the internal states 231 to 235 are expressed by internal states x31 to x35, respectively. A common input (common resource) u0 is input to the subsystems 21 to 23, and individual inputs u1 to u3 are input to the subsystems 21 to 23, respectively. In other words, the subsystems share the common resource in this and following embodiments. Note that values of the individual inputs u1 to u3 can be different from each other.

In the distributed management approach, the local optimizer must estimate an effect of the neighboring subsystem to appropriately control the corresponding subsystem. Hereinafter, a relation between two subsystems that affect each other is referred as a “coupling”. The effect of the neighboring subsystem is dominant in an area in the present subsystem that is close to the neighboring subsystem. Hereinafter, such area is referred to as a border area and the internal state in the border area is referred to as a border internal state. In FIG. 1, in the subsystem 21, the border point is the internal state 215 that is close to the subsystem 22. In the subsystem 22, the border state is the internal point 221 that is close to the subsystem 21 and the internal state 225 that is close to the subsystem 23. In the subsystem 23, the border state is the internal point 231 that is close to the subsystem 22.

The local optimizer 11 estimates the effect of the neighboring subsystem 22 to appropriately control the corresponding subsystem 21. The local optimizer 12 estimates the effects of the neighboring subsystems 21 and 23 to appropriately control the corresponding subsystem 22. The local optimizer 13 estimates the effect of the neighboring subsystem 22 to appropriately control the corresponding subsystem 23. In this case, the effect that the subsystem 21 receives from the subsystem 22 is expressed as “k1{x15, x21}”, also called flow. In the present invention, the word “flow” means a flow of a physical entity (ex. heat conduction, heat exchange etc.). Hereinafter, the flow is referred to as a physical flow. The effect that the subsystem 22 receives from the subsystem 21 is expressed as “k1{x21, x15}”. The effect that the subsystem 22 receives from the subsystem 23 is expressed as “k2{x25, x31}”. The effect that the subsystem 23 receives from the subsystem 22 is expressed as “k2{x31, x25}”.

Then, an output of each subsystem is expressed by a function variants of which are the common input u0, the individual input (any of the individual input u1 to u3), and the effect of the neighboring subsystem. Therefore, in the distributed management approach, each local optimizer has to monitor the internal states of the corresponding subsystem and the effect of the neighboring subsystem in order to optimize each of outputs y1 to y3 of the subsystems 21 to 23. In other words, each local optimizer has to receive the state information of the border point in the neighboring subsystem from the neighboring local optimizer and send the state information of the border point in the corresponding subsystem to the neighboring local optimizer for converging the output of the corresponding subsystem into a predetermined criteria (e.g., a predetermined value or a predetermined range). Thus, information exchanges for optimizing the operations of the subsystems are performed among the local optimizers and several optimization cycles are needed to achieve convergence. Note that dashed lines in FIG. 1 represent communication paths for receiving information of the common output u0 and individual outputs u1 to u3, and communication paths between the local optimizer 11 to 13 and the mediator 10.

Especially, when the output of the corresponding subsystem is precisely controlled, frequency of the information exchanges is increased. Further, when the output cannot be reached the predetermined criteria, the high frequency information exchange will be continuously kept. Furthermore, tightness of the coupling between two subsystems also affects the frequency of the needed information exchanges and number of optimization cycle.

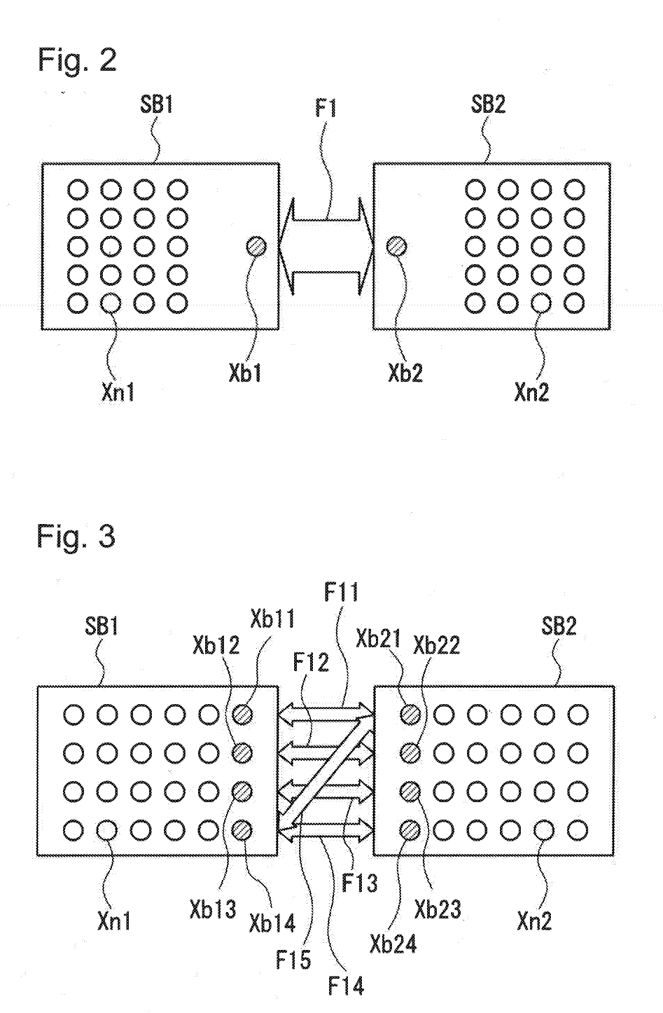

Here, the tightness of the coupling between two subsystems shall be described in detail. FIG. 2 is a diagram schematically showing an example of tight coupling between two subsystems. As shown in FIG. 2, the subsystem SB1 includes one border internal states Xb1 and a plurality of internal state (Xn1) that are not the border internal states. The subsystem SB2 includes one border internal state Xb2 and a plurality of internal state (Xn2) that are not the border internal states. In this case, a physical flow F1 between the border internal states Xb1 and the border internal state Xb2 are extremely high. Therefore, the coupling between the subsystems SB1 and SB2 is tight, and the information exchange for the purpose of distributed optimization has to be frequently performed.

FIG. 3 is a diagram schematically showing another example of tight coupling between two subsystems. As shown in FIG. 3, the subsystem SB1 includes a plurality of border internal states Xb11 to Xb14 and a plurality of internal state (Xn1) that are not the border states. The subsystem SB2 includes a plurality of border internal states Xb21 to Xb24 and a plurality of internal state (Xn2) that are not the border states. In this case, physical flows F11 to F14 between the border internal states Xb11 to Xb14 and the border internal states Xb21 to Xb24, respectively. Further, a physical flow F5 between the border internal state Xb14 and the border internal state Xb21. Each of the physical flows F11 to F15 is not high, however, total volume of the physical flows F11 to F15 is large. Therefore, the coupling between the subsystems SB1 and SB2 is also tight as in the case shown in FIG. 2, and the information exchanges has been frequently performed for distributed optimization (management).

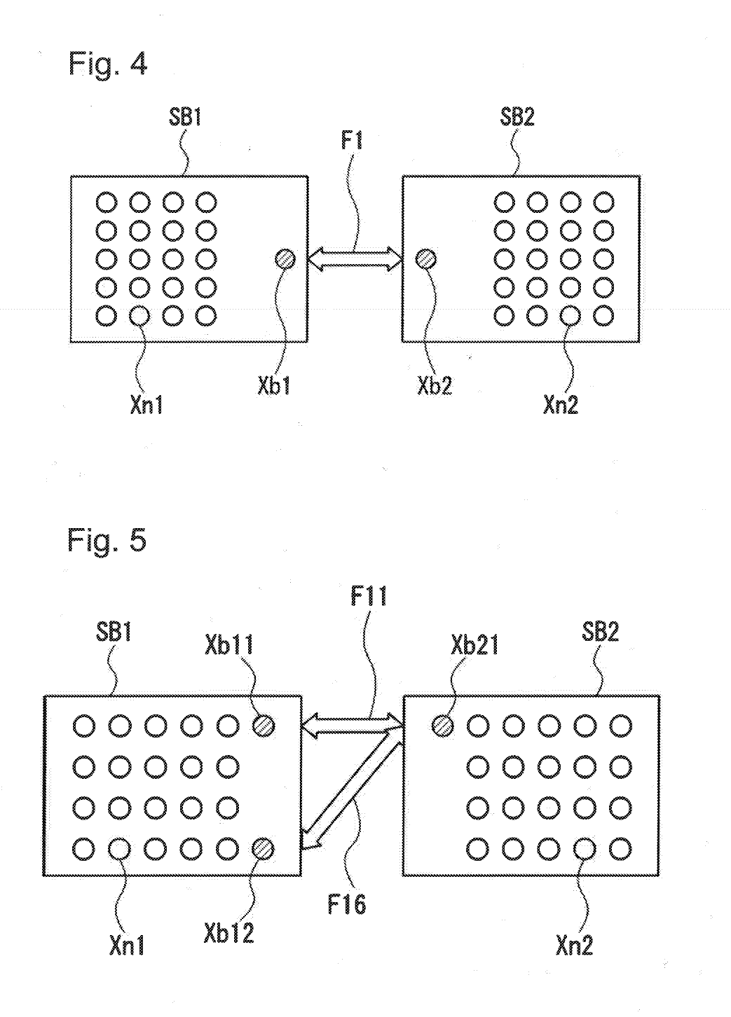

FIG. 4 is a diagram schematically showing an example of loose coupling between two subsystems. As shown in FIG. 4, the configuration s of the subsystems SB1 and SB 2 are the same as those shown in FIG. 2, description of those are omitted. However, in this case, the physical flow F1 between the border internal state Xb1 and the border internal state Xb2 are not high. Therefore, the coupling between the subsystems SB1 and SB2 is loose.

FIG. 5 is a diagram schematically showing another example of loose coupling between two subsystems. As shown in FIG. 5, the subsystem SB1 includes two border internal states Xb11 and Xb12 and a plurality of internal state (Xn1) that are not the border states. The subsystem SB2 includes one border internal states Xb21 and a plurality of internal state (Xn2) that are not the border states. In this case, a physical flow F11 between the border internal state Xb11 and the border internal state Xb21. Further, a physical flow F16 between the border internal state Xb12 and the border internal state Xb21. Each of the physical flows F11 and F16 is not high, and there are only two information exchanges. Thus, total volume of the physical flows F11 and F16 is smaller than the case shown in FIG. 3. Therefore, the coupling between the subsystems SB1 and SB2 is loose.

In this embodiment, for solving the problem due to the above-mentioned conventional distributed approach, the mediator 10 reinitializes one or more local optimizers as appropriate. Specifically, the mediator 10 changes the appropriately change operation state of one or more local optimizers. In sum, the mediator 10 monitors some internal states or internal conditions of the optimizers of the local subsystems and regularly checks whether these internal states or internal conditions satisfy the criteria. Then the mediator 10 change the operation state of the local optimizers the outputs of which cannot satisfy the criteria.

When the output is not converged into the predetermined criteria (ex. number of optimization cycles), the mediator 10 changes the parameters for operation of the local optimizer. For, example, these parameters are included in the above-mentioned function the variants of which are common input u0, individual input (any of the individual input u1 to u3), and the effect of the neighboring subsystem.

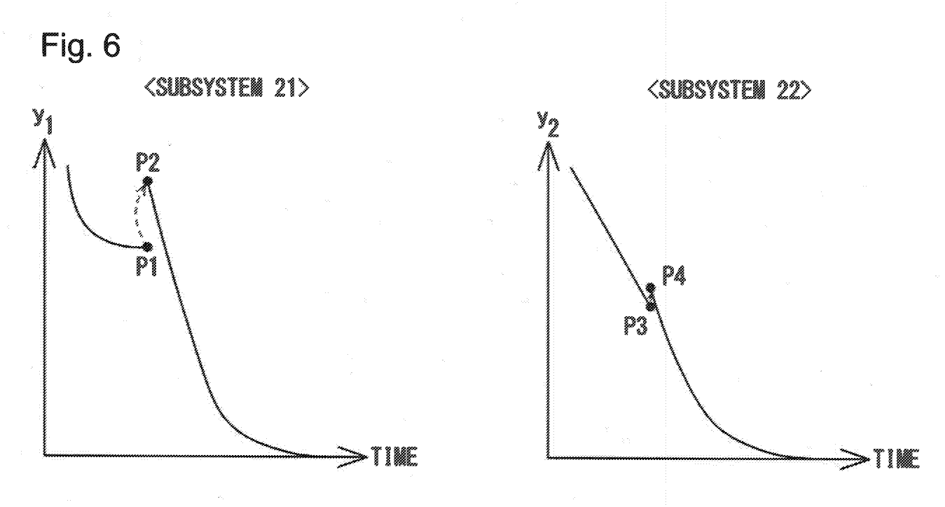

FIG. 6 is a graph schematically showing a parameter change of the optimization system 100 according to the first embodiment. In this example, a case that the output y1 of the subsystem 21 cannot be converged under the predetermined criteria y1th is described. When the mediator 10 detects that the output y1 cannot reach the criteria Y1th, the mediator changes the parameters of the local optimizer 11 (ex. changing initial values or constraints) (refer to P1 in FIG. 6). Thus, operation state of the optimizer of the subsystem 21 is changed (refer to P2 in FIG. 6). After that, the output y1 converges under the criteria y1th when the changed parameters are appropriate values. On the other hand, the parameters of the neighboring subsystem 22 are not changed. Thus, although the subsystem 22 is affected by the parameter change of the subsystem 21, variation of the operation state of the optimizer of the subsystem 22 is not so large (refer to P3 and P4 in FIG. 6) because the parameters of the subsystem 22 are not changed. Therefore, the output y2 of the subsystem 22 can be converged regardless of the effect due to the parameter change (ex. Changing initial values or constraints) of the subsystem 21.

Further, another method for solving the problem due to the above-mentioned conventional distributed approach shall be described. As described above, in the coupling mode in which the normal operations of the coupled subsystems are executed, the information exchanges are executed among the local optimizers.

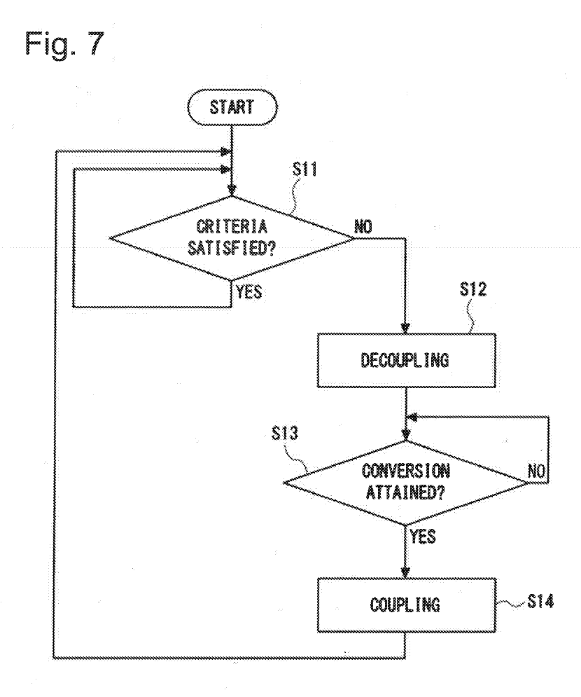

FIG. 7 is a flowchart showing a process of an operation mode change of the optimization system 100 according to the first embodiment. In this method, the mediator 10 changes the operation mode of the local optimizers from a coupling mode into a decoupling mode when the output is not converged into the predetermined criteria.

### Step S11

The mediator 10 monitors some internal states of the subsystems or internal conditions of the optimizers and checks whether the monitored output satisfies the predetermine criteria.

### Step S12

When the monitored output is not satisfied the predetermined criteria, the mediator changes the operation mode of the local optimizer corresponding to the subsystem from the coupling mode into the decoupling mode. In the decoupling mode, the information exchanges are stopped by providing the local optimizer with limited (fixed) internal state as the border state (ex. lower and upper time variant bounds of the respective states). The limited internal state is an internal state limited to a certain range or value. For example, when the output y1 of the subsystem 21 is not converged to the predetermined criteria, the mediator 10 provides the local optimizer 11 with bound B21 for the internal state X21, which is a fixed range, instead of the real internal state X21. Further, the mediator 10 provides the local optimizer 12 with bound B15 for the internal state X15, which is a fixed range, instead of the real internal state X15. Thus, the local optimizer need not obtain the information of the internal state X15 and X21, and the information exchanges for the internal state X15 and X21 can be omitted. Therefore, whole amount of the information exchange is reduced so that the optimization operation speed is not delayed or improved compared with mediator less distributed optimization.

### Step S13

After changing the operation mode of the local optimizer 11, the mediator 10 continues to monitor the internal state and/or the output y1 of the subsystem and checks whether the output y1 reaches second criteria.

### Step S14

When the output y1 reaches second criteria, the mediator 10 can change the operation mode of the local optimizer 11 from the decoupling mode into the coupling mode. In this method, the second criteria is the same as the first criteria, or closer to the first criteria than the value of the output at the mode change from coupling mode to the decoupling mode. After returning to the coupling mode, the normal distributed management scheme is applied to the local optimizer 11. After that, the process will be back to the step S11.

Note that iteration count of the coupling/decoupling process (the step S11 to S14) may be limited to the predetermined number. In this case, when the iteration count reaches the limitation, the process may be coercively stopped.

Further the above-mentioned limitation (bound) is set to satisfy demands for humans. In other words, humans can be comfortable in a circumstance in the subsystem generated by the limitation (air flow speed, temperature, humidity, etc.).

According to the configuration described above, when the outputs of the subsystems cannot be converged, the optimization system 100 can change the operation state of the local optimizers to converge the corresponding outputs. As a result, the optimization system 100 can achieve the optimized operation.

### Second Embodiment

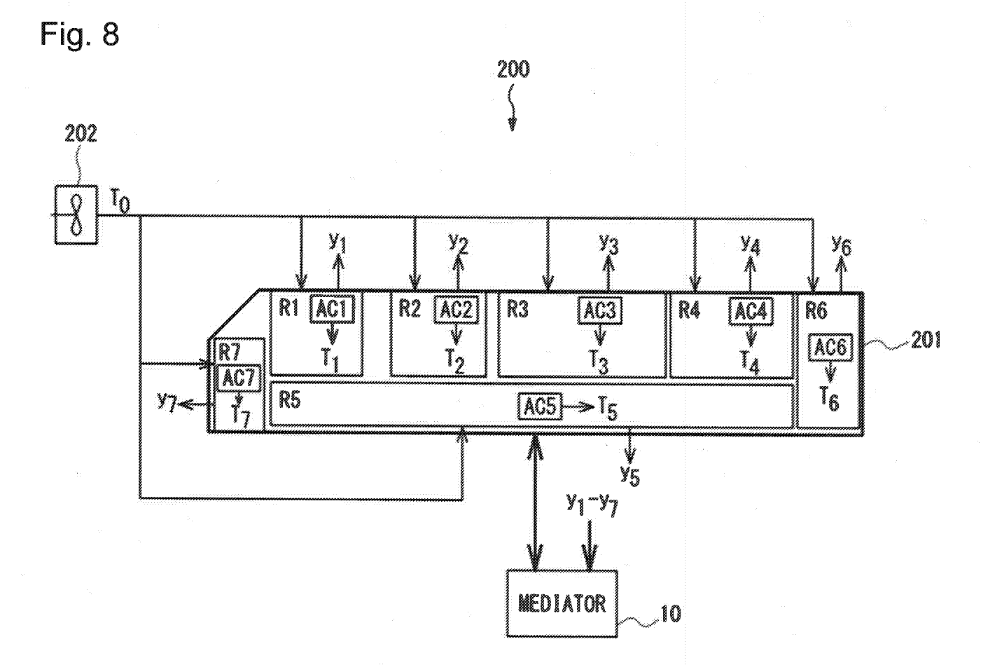

A building air conditioning system 200 according to a second embodiment, which is an aspect of the optimization system 100 according to the first embodiment, shall be described. FIG. 8 is a plane view schematically showing an example of a floor plan of a building according to the second embodiment. The floor 201 is divided into seven regions R1 to R7 that correspond to subsystems.

An air handling unit 202, which is equipped with a fan, supplies common air flow with temperature T0. The air flow temperature T0 corresponds to the common input u0. Local air conditioners AC1 to AC7, which correspond to the local optimizers, are provided in the regions R1 to R7, respectively. Local air flows with temperatures T1 to T7 from the air conditioner AC1 to AC7 correspond to the individual inputs u1 to u7, respectively. Temperatures of a plurality of points in each of the regions R1 to R7 are monitored by the corresponding air conditioners AC1 to AC7, respectively.

In this case, outputs of the regions R1 to R7 are power consumptions of the air conditioner AC1 to AC7. This system is managed to minimize the power consumptions P1 to P7. Thus, when there are not any power consumptions that can reach the predetermined criteria, the air conditioners AC1 to AC7 changes parameters for controlling the corresponding regions R1 to R7, or changes the operation mode of the corresponding regions R1 to R7, respectively, as in the case of the first embodiment.

According to the configuration described above, when the power consumptions of the regions cannot be converged, the optimization system (the building air conditioning system 200) can change the operation state of the local optimizers (controlling the air conditioners AC1 to AC7) to converge the corresponding outputs. As a result, the building air conditioning system 200 can achieve the optimized operation.

Note that the demand response function with the air conditioning in this embodiment corresponds to the task fulfilling parameter which is a predetermined energy or power level that should be kept under a certain level. Further, for example, in this embodiment, how well temperature bounds for human comfort in each subsystem are kept by the computed command from the local optimizer (ex. calculated by the product of mean violation from temperature range, mean violation time from temperature range).

### Third Embodiment

A distributed management system 300 according to a third embodiment, which is an aspect of the optimization system 100 according to the first embodiment, shall be described. The day-ahead decision regarding energy matching operation among various energy consumers and energy producers is important for a service provider (SP) in order to reduce the involvement of utility interaction. However, when the number of customers (i.e. energy consumers and energy producers) increases significantly with heterogeneity of the customers, the energy matching operation becomes complicated and difficult to manage. Therefore, the SP divides the service region based on certain criteria. The criteria may be geographical location, customer segmentation, service segmentation, etc.

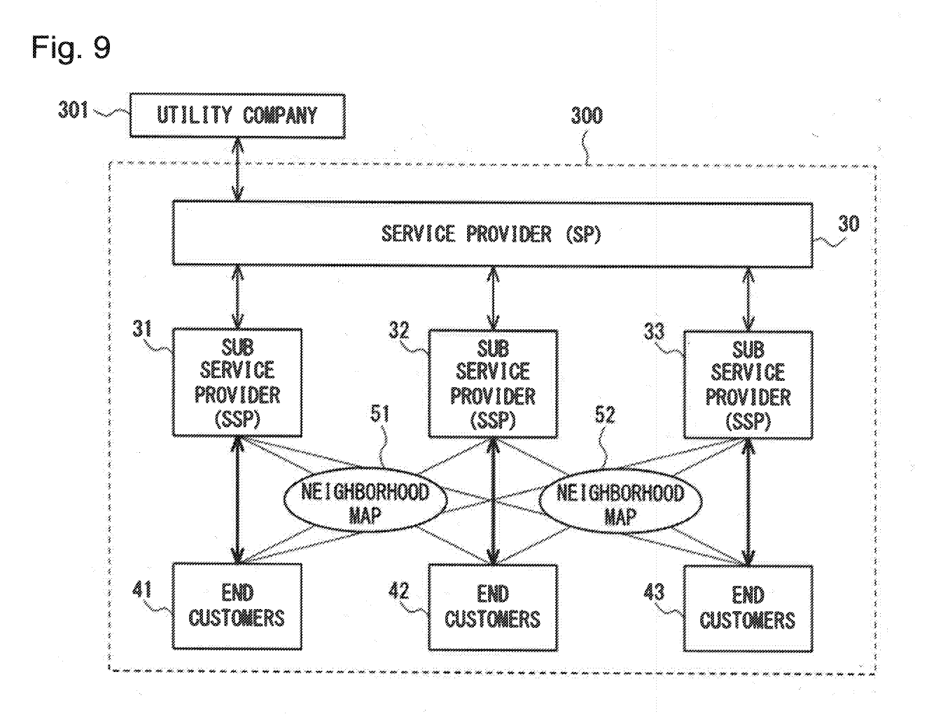

FIG. 9 is a block diagram schematically showing a configuration of the distributed management system 300 according to the third embodiment. The distributed management system 300 is configured to correspond to a commitment based energy service (CES) framework.

In this embodiment, the SP 30 functions as a mediator as in the case of the mediator described in the above-mentioned embodiments. The SP 30, which occasionally exchange energy with utility company 301, assigns each service region to a special entity namely sub service providers (SSP) 31 to 33. The SSP can essentially be a micro-grid or an aggregator. Functionality wise, each SSP can act as an Agent. Basically, the SSPs 31 to 33 are provided between the SP 30 and the corresponding end customers 41 to 43, respectively. The SSP performs local energy matching operation among the corresponding customers (energy consumers and energy producers). The access or the deficit of energy determined while performing local energy matching operation will be exchanged with another SSP under the same SP in order to provide the balance between total supply and total demand of energy. Such equilibrium of energy matching can be achieved by performing distributed optimization among the SSPs. The goal of the distributed matching operation is to attain the maximized energy interactions among the SSPs that eventually minimize the utility interactions (with the utility company 301).

Therefore, in this context, the coupling variables, that needed to be exchanged between two particular SSPs, are the current surplus/deficit of energy for associated SSPs. Moreover, the communication protocol is assumed to be synchronous, since, at a particular time and for a particular SSP, the local energy matching engine should perform the energy matching operation while taking the energy status of other SSPs into account in a mutual exclusive manner.

For example, at a particular instance of distributed matching operation, the SSP 31 contains 10 kWh of surplus of energy, while the SSP 32 and SSP 33 contain 6 kWh and 7 kWh of energy deficiency. In this case, the SSP 31 broadcasts the information regarding 10 kWh of excess supply to the SSP 32 and SSP 33. Since, the distributed operation is a synchronous one with mutual exclusion (i.e. at a certain time, only one SSP performs the local matching considering the energy status of the other SSPs), the SSP 32 (let's suppose) will perform energy exchange operation and receives 6 kWh from SSP 31 and thereby updating the energy status of the SSP 31 and SSP 32. The updated energy status of SSP 31 and SSP 32 are 4 kWh (surplus) and 0 kWh, respectively. The SSP 33 then performs the local matching operation considering the updated energy status from SSP 31 and SSP 32. After the performance of matching operation from the SSP 33, the energy status of the SSP 31 and SSP 33 are upgraded to 0 kWh and 3 kWh (deficit), respectively.

However, communication overhead increases with the number of the SSPs (in an order of N2, where N is the number of SSP; for a meshed communication protocol). Moreover, in certain cases, two SSPs can be spatially very far away to perform an energy exchange operation. In this case, performing the distributed matching operation for meshed network is expensive and unnecessary. The problem can be solved if each SSP, based on their energy status and geographical location, contains neighborhood maps 51 and 52. The neighborhood map of the particular SSP incudes the information of the neighbor SSPs to which the SSP can exchange energy.

Thus, the mediator such as the mediator 10 described in the first embodiment is required to perform above mentioned operation. In this embodiment, the SP functions as the mediator in order to manage the distributed matching operation. Moreover, the mediator occasionally provides the upgraded neighborhood map to each SSP to facilitate the distributed matching operation. For example, the neighborhood map can be determined by the SSP coalition formation method. The basic idea of the coalition formation method (in the context of micro-grids) shall be described.

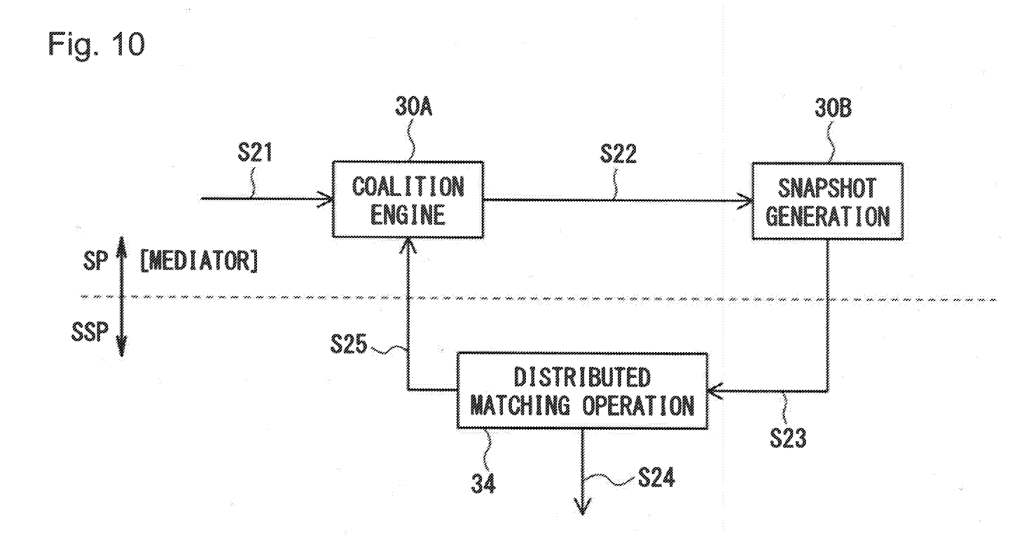

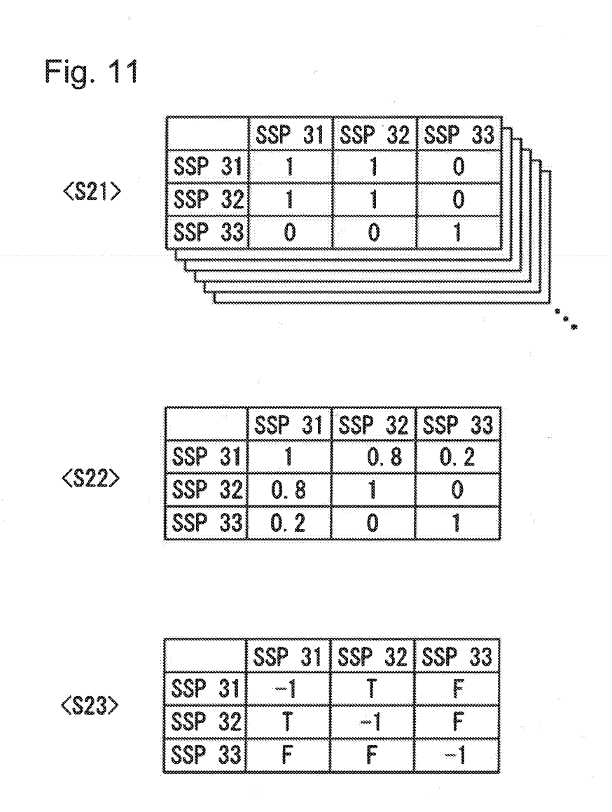

FIG. 10 is a diagram schematically showing the coalition formation method. The interaction between the mediator (SP 30) and the agent (SSPs 31 to 33) in case of generating the neighborhood map is shown in FIG. 10.

### Step S21

The mediator (SP 30) receives the historical energy status for each SSP. A coalition engine 30A in SP 30 determines the energy based coalition among SSPs.

### Step S22

The coalition engine 30A maintains a belief neighborhood map (BNM) that contains a skeleton of neighborhood map using a probabilistic prior. A snapshot generation 30B takes the BNM and generates a snapshot of actual neighborhood map (ANM). The belief update process is conducted while considering the upgraded energy status from each SSP.

### Step S23

The mediator will delegate the ANM only if there is a significant update in BNM. The Coalition Engine utilizes a learning scheme (e.g. Bayesian Learning) to update the BNM using the observation (updated energy status).

### Step S24

The distributed matching operation (in SSP) 43 utilizes the ANM (or an updated ANM in case of delegation from SP) to perform matching operation with the exchange of energy information with other SSPs. The offline matching decisions are provided to the customers (operating under that particular SSP) and other SSPs.

### Step S25

The updated energy status (prior to matching operation) of that particular SSP is sent back to the coalition engine 30A to update the BNM and the process continues.

Note that, the mediator (SP) only interferes with the distributed matching operation if there is a significant updates in the BNM. Other time, the SP lets the SSPs to carry on their local matching operation with information exchange with other SSPs.

FIG. 11 is a diagram showing an example of the ANM generation. The coalition formation engine will form coalition among SSPs based on the historical energy status (the step S21). In the example, if two SSPs are in same coalition, the corresponding entry will be marked as “1”.

The formed matrix and prior belief will generate the updated BNM (the step S22). In this case, SSP 31 and SSP 32 are likely to be at the same coalition with an 80% probability.

If the updated BNM is significantly different than the prior belief, the snapshot generation will generate the ANM (the step S23). If rand(0, 1)<=the value in the ANM, the corresponding entry will be marked as “T”. Otherwise, the corresponding entry will be marked as “F”.

In FIG. 11, the prior and updated BNM varies significantly. Therefore, the SP will interfere with the operation of SPs by providing then a new ANM generated by the snapshot generators.

According to the configuration described above, when the balance of the power consumption and production of the end consumers 41 to 43 cannot be converged, the optimization system (the distributed management system 300) can change the operation state of the local optimizers to converge the corresponding outputs. As a result, the distributed management system 300 can achieve the optimized operation.

### Other Embodiment

The present invention is not limited to the above exemplary embodiments, and can be modified as appropriate without departing from the scope of the invention. For example, in the embodiments described above the examples in which the number of the local optimizers and the subsystems is three or seven, however, it is merely an example. Thus, the number of the local optimizers and the subsystems may be an arbitrary plural number other than three and seven.

### REFERENCE SIGNS LIST

10 MEDIATOR

11 to 13 LOCAL OPTIMIZERS

21 to 23 SUBSYSTEMS

30 SERVICE PROVIDER (SP)

30A COALITION ENGINE

30B SNAPSHOT GENERATION

31 to 33 SUB SERVICE PROVIDERS (SSP)

34 DISTRIBUTED MATCHING OPERATION

41 to 43 END CUSTOMERS

51 and 52 NEIGHBORHOOD MAPS

100 OPTIMIZATION SYSTEM

200 BUILDING AIR CONDITIONING SYSTEM

201 FLOOR

202 AIR HANDLING UNIT

300 DISTRIBUTED MANAGEMENT SYSTEM

301 UTILITY COMPANY

AC1 to AC7 AIR CONDITIONERS

R1 to R7 REGIONS

What is claimed is:

1. An optimization system, comprising:
a plurality of subsystems that have one or more internal states;
a plurality of local optimizers that control the corresponding subsystems based on the internal states thereof and data exchange due to a coupling between the subsystems, respectively; and
a mediator that monitors outputs and/or some internal states of the plurality of subsystems and controls operations of the plurality of local optimizers based on the internal states and/or outputs thereof, wherein
each of a first subsystem and a second subsystem is one of the plurality of subsystems, and a first internal state that is the close to the second subsystem in the first subsystem is affected by a second internal state that is close to the first subsystem in the second subsystem, or
the first and second subsystems share a common resource.

2. The optimization system according to claim 1, wherein the internal state is a task fulfilling parameter, a management performance indication, an optimization convergence parameter, or an optimization constraints fulfilling parameter.

3. The optimization system according to claim 2, wherein the internal state is a subset of the task fulfilling parameter, the management performance indication, the optimization convergence parameter, or the optimization constraints fulfilling parameter.

4. The optimization system according to any one of claim 1, wherein
the local optimizer controls the operation of the corresponding subsystem using a function variants of which are the internal states and the effect of the neighboring subsystem, and
the mediator changes parameters that affects the variants in the function when the output of the corresponding subsystem is not satisfied predetermined criteria.

5. The optimization system according to any one of claim 1, wherein
the mediator limits the second internal states to a predetermined range or value when the output of the first subsystem does not satisfy predetermined criteria, and
information exchanges of the first internal state and the second internal state between the local optimizers corresponding to the first and second subsystems are stopped.

6. The optimization system according to claim 5, wherein the mediator stops limiting the second internal states to the predetermined range or value when the output of the corresponding subsystem satisfies the predetermined criteria.

7. The optimization system according to claim 6, wherein the mediator iteratively executes a cycle consisting of limiting the second internal state and stopping limiting the second internal state.

8. The optimization system according to claim 7, wherein a number of iteration of the cycles is predetermined.
